(19) United States
(12) Patent Application Publication
(10) Pub. No.: US 2014/0372946 A1
(43) Pub. Date: Dec. 18, 2014

(54) Systems for Obtaining, Analyzing, and Adjusting User Provided Economic Priority Parameters to Anticipate and Adjust Future Results

(71) Applicant: United Capital Financial Advisers, LLC, Newport Beach, CA (US)

(72) Inventors: Joseph Duran, Newport Beach, CA (US); Michael Duncan, Bronxville, NY (US); Mark Ciucci, Wolverine Lake, MI (US); Leslie Dunham, Irvine, CA (US); Jason Del Col, Laguna Beach, CA (US); Brandon Gage, Bay City, MI (US)

(21) Appl. No.: 14/472,846

(22) Filed: Aug. 29, 2014

Related U.S. Application Data
(63) Continuation-in-part of application No. 13/690,854, filed on Nov. 30, 2012.

(51) Int. Cl. G06F 3/0484; G06Q 10/06

(52) U.S. Cl. CPC G06F 3/04842; G06Q 10/0637
USPC 715/810

(57) ABSTRACT

A method for analyzing inputs from a user to modify a financial plan with a computer system is disclosed. The method may also include displaying a plurality of images to the user, where each of the plurality of images is associated with a different query, and receiving an instruction to randomly select a subset of the plurality of images. The method may additionally include selecting, randomly, a subset of the plurality of images for presentation to the user and displaying the subset of the plurality of images in a different manner from a remainder of the plurality of images. The method may moreover include repeating, for every image of the subset: receiving a selection of one of the images; displaying to the user a query; and receiving an answer. The method may also include determining from the answers, a classification of the user's attitude toward financial resources and storing the classification.

### CROSS-REFERENCE TO RELATED APPLICATIONS

This application is a continuation-in-part of U.S. patent application Ser. No. 13/690,854 filed Nov. 30, 2012, entitled “SYSTEMS AND METHODS FOR OBTAINING PRIORITIZED USER INPUT,” the entire disclosure of which is hereby incorporated by reference, for all purposes, as if fully set forth herein.

### BACKGROUND OF THE INVENTION

This invention relates generally to adviser/client interactions. More specifically the invention relates to assisting clients in various fields, including financial and retirement consulting, in determining what their short and/or long term priorities are, what financial commitments they are willing to make, and communicating them to an adviser or other third party who may further assist in determining the significance of each priority and actions that can be taken with respect thereto, along with the impact changes in such priorities and commitments will have.

### BRIEF DESCRIPTION OF THE INVENTION

In one embodiment, a method for receiving and analyzing inputs from at least one user to modify a financial plan of the at least one user with a computer system is provided. The method may include receiving, at the computer system, biographical information from a first user. The method may also include displaying, by the computer system, a plurality of images to the first user, where each of the plurality of images is associated with a different query for the first user. The method may further include receiving, at the computer system, an instruction from the first user to randomly select a subset of the plurality of images. The method may additionally include selecting, randomly, by the computer system, a subset of the plurality of images for presentation to the first user. The method may furthermore include displaying, by the computer system, to the first user the subset of the plurality of images in a different manner from a remainder of the plurality of images. The method may moreover include repeating, for each and every image of the subset of images: receiving, at the computer system, from the first user a selection of one of the subset of the plurality of images; displaying, by the computer system, to the first user a query associated with the selection; and receiving, at the computer system, an answer from the first user to the query associated with the selection. The method may also include determining, by the computer system, from the answers for the queries associated with the images, a classification of the first user's attitude toward financial resources. The method may further include storing, by the computer system, the classification in association with the first user's biographical information.

In another embodiment, a system for receiving and analyzing inputs from at least one user to modify a financial plan of the at least one user is provided. The system may include a computer system, and the computer system may be for receiving biographical information from a first user. The computer system may also be for displaying a plurality of images to the first user, where each of the plurality of images is associated with a different query for the first user. The computer system may further be for receiving an instruction from the first user to randomly select a subset of the plurality of images. The computer system may additionally be for selecting, randomly, a subset of the plurality of images for presentation to the first user. The computer system may furthermore be for displaying to the first user the subset of the plurality of images in a different manner from a remainder of the plurality of images. The computer system may moreover be for repeating, for each and every image of the subset of images: receiving from the first user a selection of one of the subset of the plurality of images; displaying to the first user a query associated with the selection; and receiving an answer from the first user to the query associated with the selection. The computer system may also be for determining from the answers for the queries associated with the images, a classification of the first user's attitude toward financial resources. The computer system may further be for storing the classification in association with the first user's biographical information.

In another embodiment, a non-transitory machine readable medium having instructions thereon, the instructions executable by a processor for receiving and analyzing inputs from at least one user to modify a financial plan of the at least one user is provided. The instructions are executable for at least receiving biographical information from a first user. The instructions may also be for displaying a plurality of images to the first user, where each of the plurality of images is associated with a different query for the first user. The instructions may further be for receiving an instruction from the first user to randomly select a subset of the plurality of images. The instructions may additionally be for selecting, randomly, a subset of the plurality of images for presentation to the first user. The instructions may furthermore be for displaying to the first user the subset of the plurality of images in a different manner from a remainder of the plurality of images. The instructions may moreover be for repeating, for each and every image of the subset of images: receiving from the first user a selection of one of the subset of the plurality of images; displaying to the first user a query associated with the selection; and receiving an answer from the first user to the query associated with the selection. The instructions may also be for determining from the answers for the queries associated with the images, a classification of the first user's attitude toward financial resources. The instructions may further be for storing the classification in association with the first user's biographical information.

### BRIEF DESCRIPTION OF THE DRAWINGS

The present invention is described in conjunction with the appended figures:

FIG. 1 shows an interface for collecting biographical information from a user;

FIG. 2 shows a collection of images associated with queries for a user;

FIG. 3 shows a subset of the images from FIG. 2 displayed in a different manner;

FIGS. 4A-4C show example queries and potential answers for a user as selected from FIG. 3;

FIGS. 5A-5C show possible classifications of a user's attitude toward financial resources;

FIG. 6 shows an example display of a user's financial control score and related information;

FIG. 7 shows information which may possibly be included in a client portal accessible by a user;

FIG. 8 shows a priority action list which may be provided to a user in one embodiment of the invention; and

FIG. 9 is a block diagram of an exemplary computer system capable of being used in at least some portion of the apparatuses or systems of the present invention, or implementing at least some portion of the methods of the present invention.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION OF THE INVENTION

The ensuing description provides exemplary embodiments only, and is not intended to limit the scope, applicability or configuration of the disclosure. Rather, the ensuing description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims. Merely by way of example, not every detail discussed with regard to one embodiment may be present in all version of that embodiment. Additionally, any specific detail discussed with regard to one embodiment of the invention may or may not be present in any other embodiment discussed herein, or version thereof

Specific details are given in the following description to provide a thorough understanding of the embodiments. However, it will be understood by one of ordinary skill in the art that the embodiments may be practiced without these specific details. For example, circuits, systems, networks, processes, and other elements in the invention may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but could have additional steps not discussed or included in a figure. Furthermore, not all operations in any particularly described process may occur in all embodiments. A process may correspond to a method, a function, a procedure, a subroutine, a subprogram, etc. When a process corresponds to a function, its termination corresponds to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments of the invention may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

In one embodiment of the invention, a method for receiving and analyzing inputs from at least one user to modify a financial plan of the at least one user with or without a computer system is provided. In these and other embodiments, a computer system to implement this and other methods of the invention may be provided. A transitory or non-transitory machine readable medium may also be provided containing instructions executable by a processor to perform the methods discussed herein.

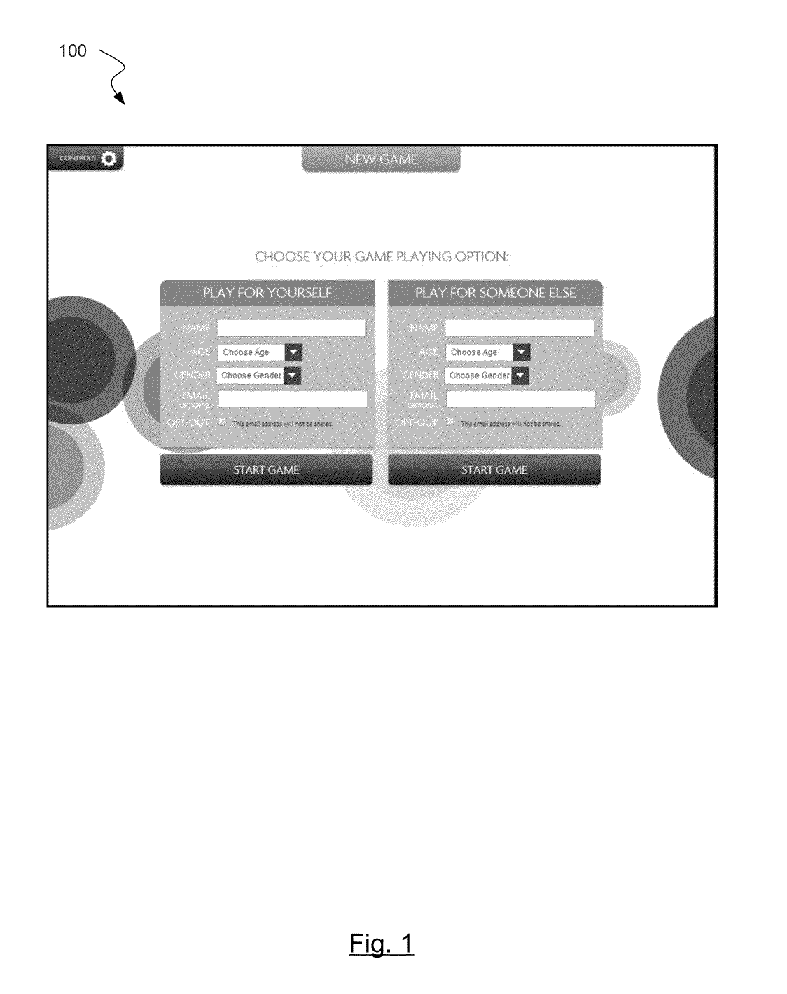

The method may include receiving, at the computer system, biographical information from a first user. Turning now to FIG. 1, one possible interface 100 for collecting such information is shown. Though interface 100 shows a name field, an age field, a gender field, and an e-mail field, other interfaces of the invention may have fewer or greater number of fields for collection of biographical information. Collection of some information may be optional for a user, as is e-mail in this example. After the user has input the minimum required information (here, name, age, and gender), the user may cause the next interface to be presented by interacting with a certain area of the interface (here, the “start game” button).

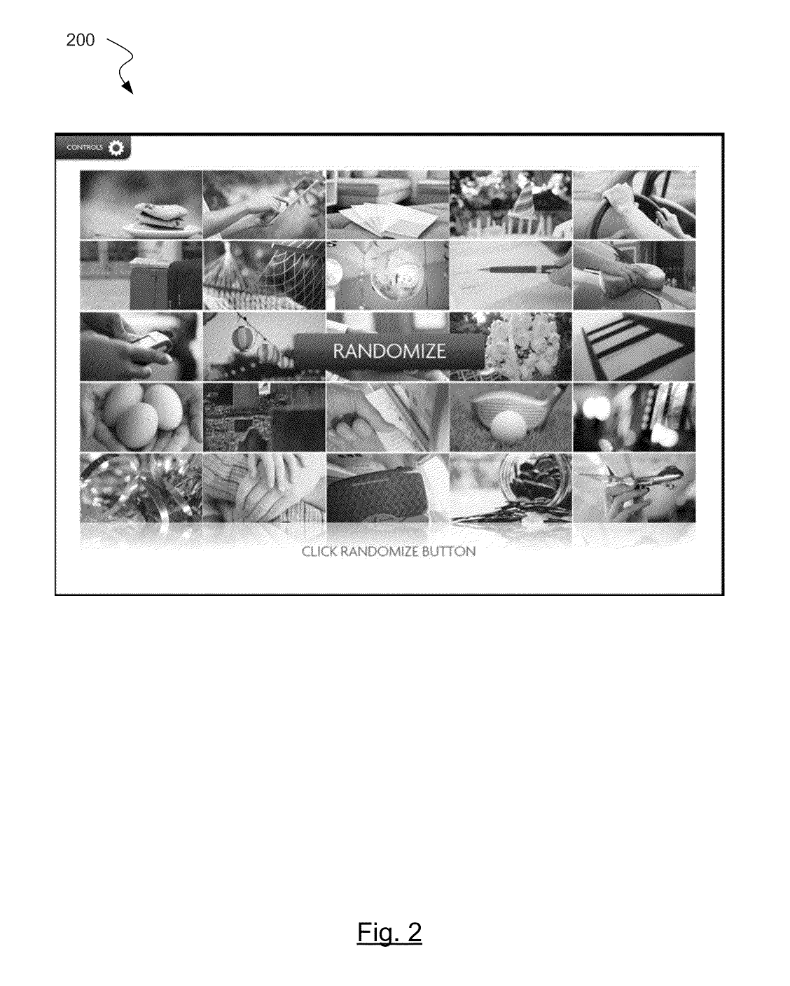

The method may then include displaying, by the computer system, a plurality of images to the first user, where each of the plurality of images is associated with a different query for the first user. As shown in FIG. 2, in one embodiment 25 images may be presented in an interface 200, with a “randomize” button located over the field of images. In other embodiments, fewer or greater number of images may be provided.

The method may further include receiving, at the computer system, an instruction from the first user to randomly select a subset of the plurality of images. In the example shown in FIG. 2, this may include receiving an interaction from the user with a certain area of the interface (here, the “randomize” button).

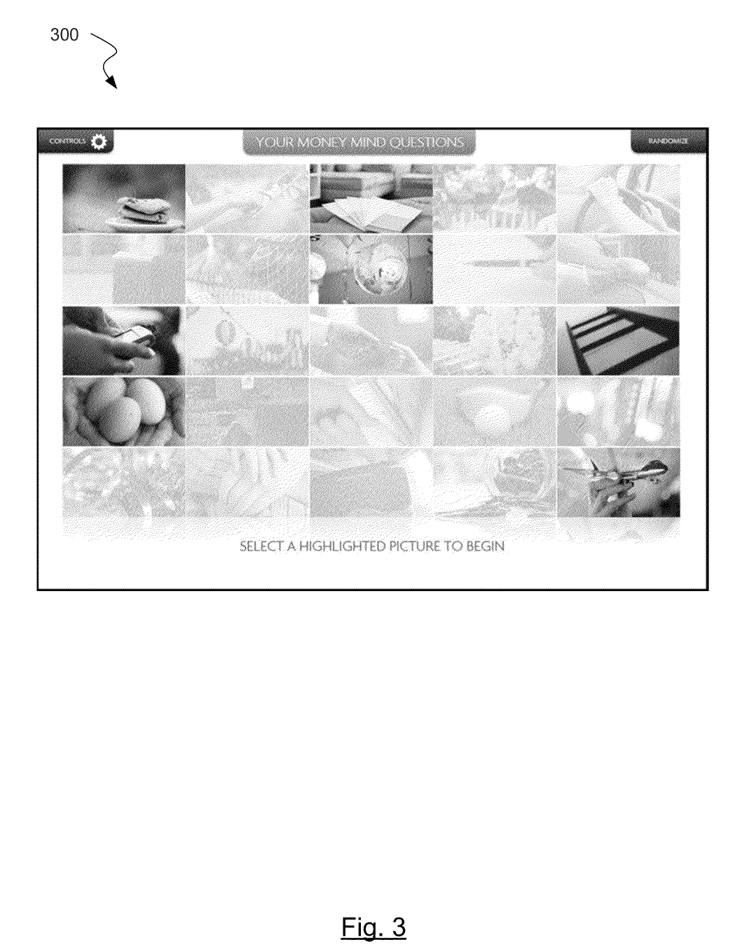

In response to receiving the instruction or interaction from the user, the method may additionally include selecting, randomly, by the computer system, a subset of the plurality of images for presentation to the first user. As shown in FIG. 3, this may result in displaying, by the computer system, to the first user the subset of the plurality of images in a different manner from a remainder of the plurality of images via interface 300. In FIG. 3, the subset of randomly selected images are shown normally, while the remainder of the images are shown in muted brightness (e.g., grayed out). Other means of differentiating the subset of images from the remainder of the images may be implemented in other embodiments.

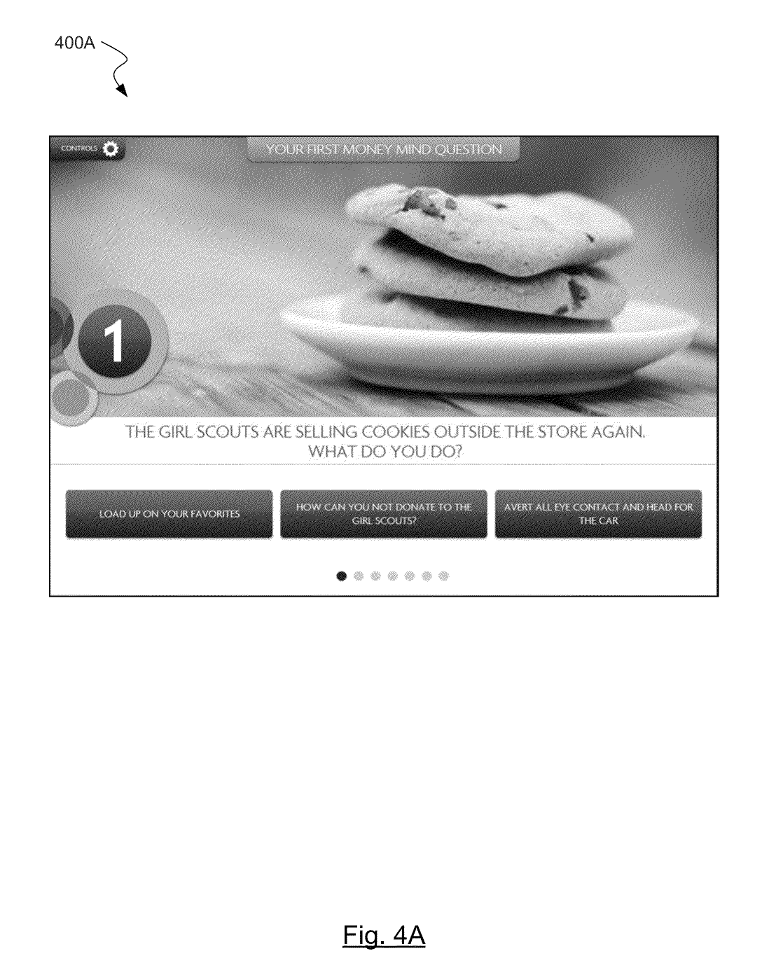

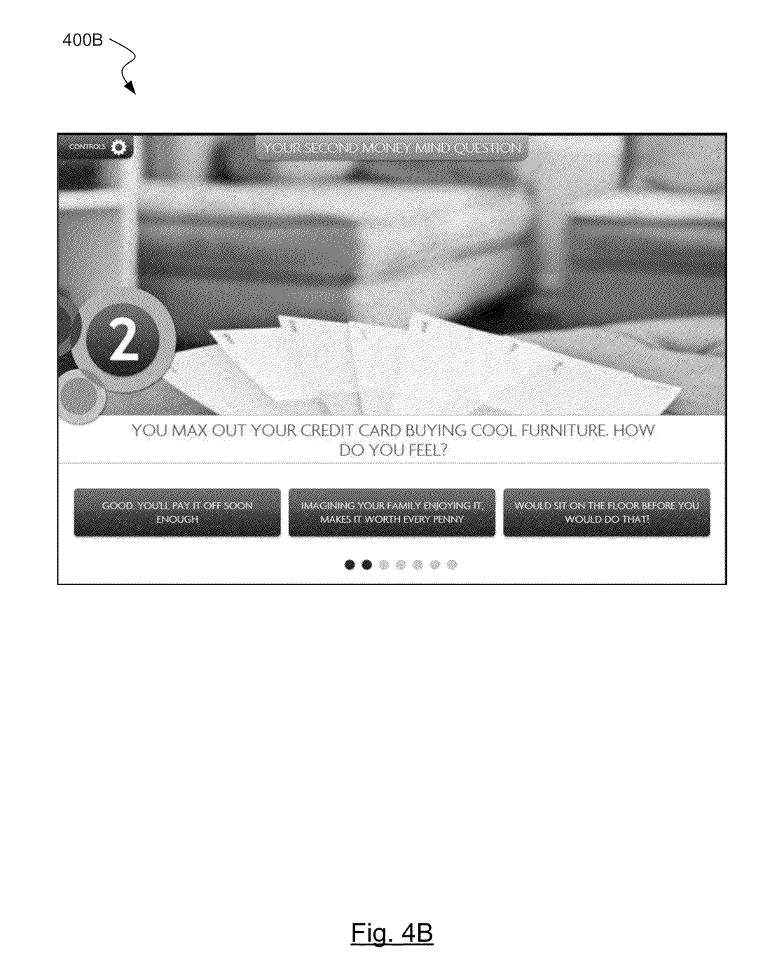

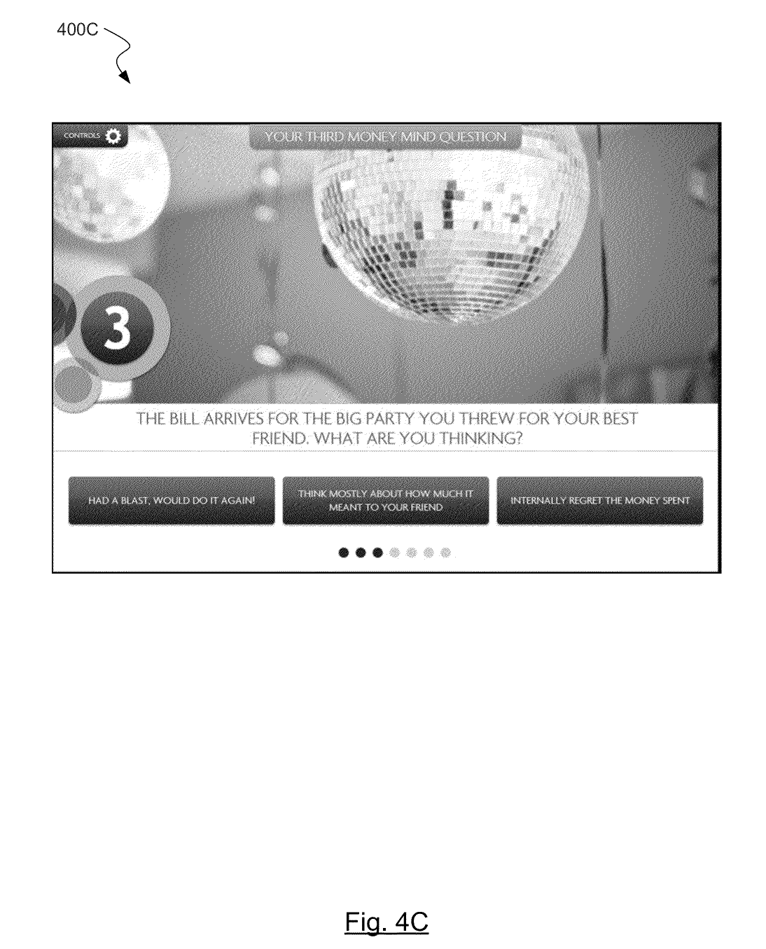

The method may then include receiving, at the computer system, from the first user, a selection of one of the subset of the plurality of images. Upon selection, the method may display, by the computer system, to the first user, a query associated with the selection. Examples of such queries, with multiple possible selectable answers, are shown in FIGS. 4A-4C via interfaces 400. The queries may be related to the pictures displayed in FIG. 3, and reproduced in greater size after selection of the images therein.

The method may further include receiving, at the computer system, an answer from the first user to the query associated with the selection. In FIGS. 4A-4E, this may occur via a selection of one of the possible selectable answers by the user on the interface. The method may also include repeating, for each and every image of the subset of images, the aforementioned process to receive answers from the user for all of the queries associated with the subset of images. Though in FIG. 3 seven images make up the subset from the total possible 25 images, in other embodiments, fewer or greater number of images may make up the subset of images. Likewise, the total number of images may vary in different embodiments.

The method may also include determining, by the computer system, from the answers for the queries associated with the images, a classification of the first user's attitude toward financial resources. In some embodiments, this may be determined by determining what percent of the user's answers to the queries correspond with a particular category of attitude. For example, each query may have three multiple choice answers, each corresponding to a particular category. If the user answers 25% of the queries with an answer from a first category, and 75% of the queries with an answer from a second category, then the user can be classified as having 25% of a first attitude toward financial resources, and 75% of a second attitude toward financial resources.

In some embodiments, one possible classification may be a fear focus, where the fear focus user has a primary goal to seek security and/or safety in their finances. Another possible classification may be a happiness focus, where the happiness focus user has a primary goal to seek satisfaction via their finances. Another possible classification may be a commitment focus, where the commitment focus user has a primary goal to take care of others with their finances.

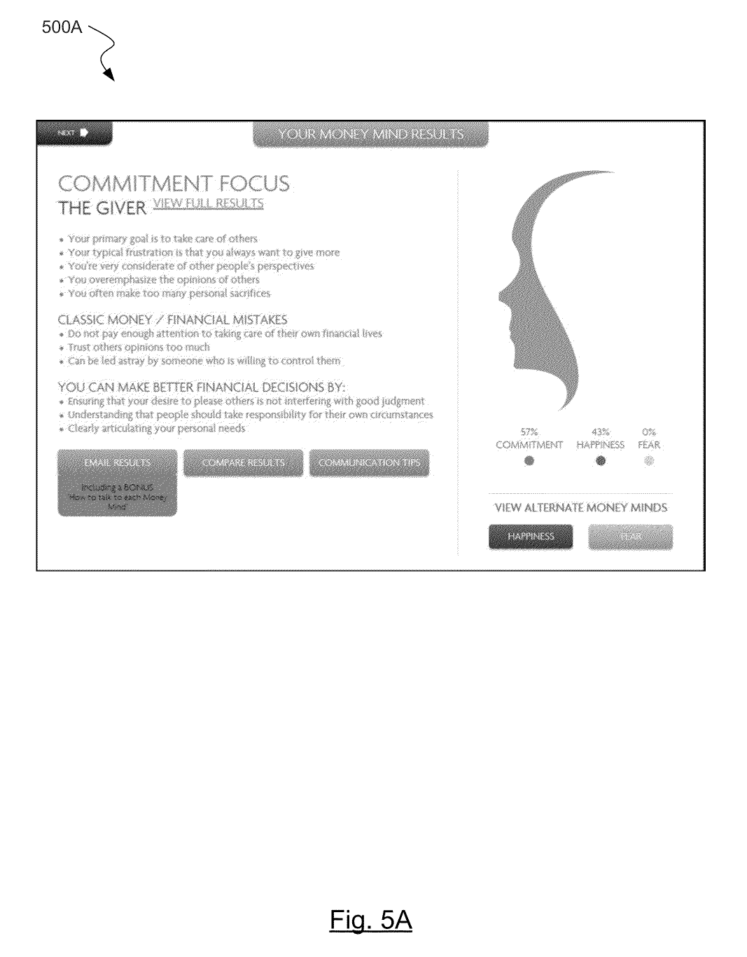

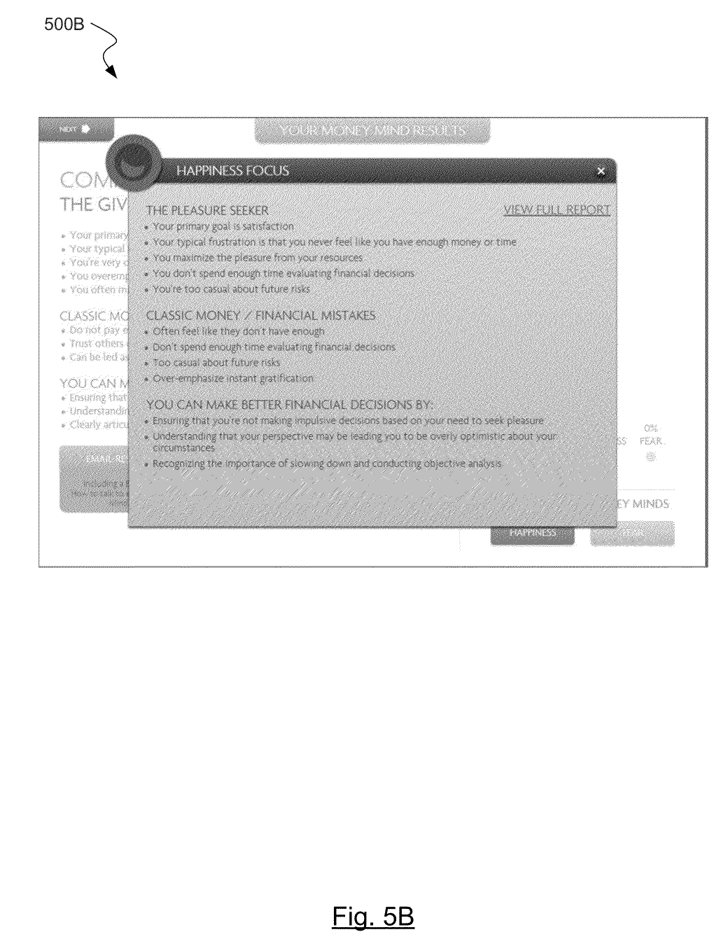

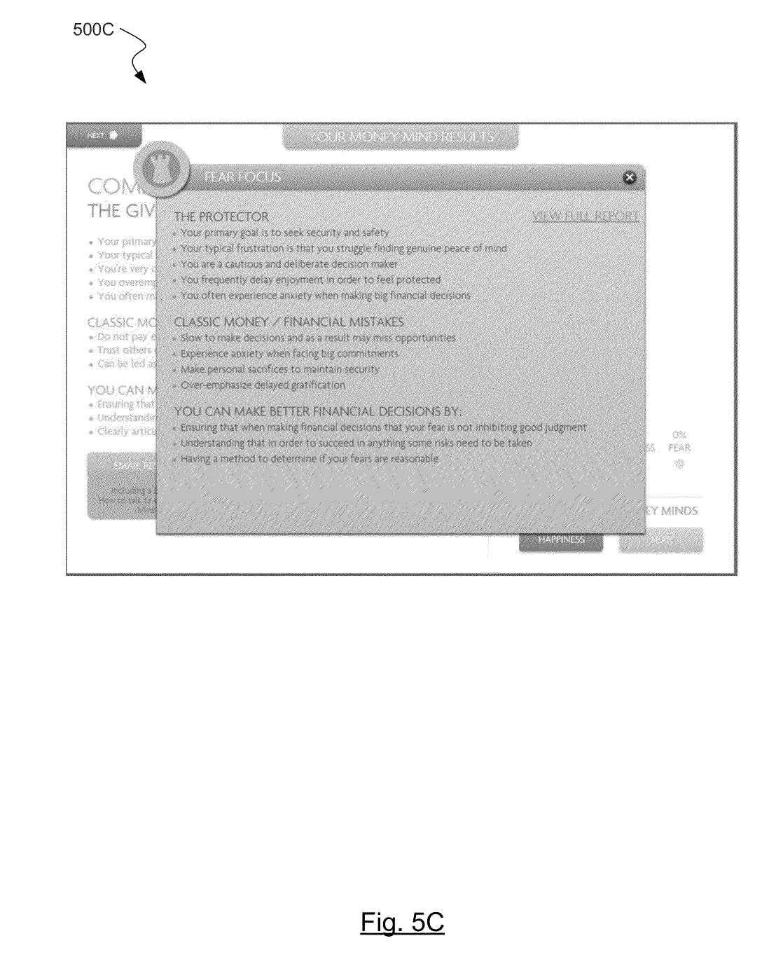

The method may further include displaying, with the computer system, to the first user their classification, and storing, by the computer system, the classification in association with the first user's biographical information. FIGS. 5A-5C shows such a display 500, and shows additional information regarding the assigned classification. The user may also be able to select the other classifications, and read similar information about such classifications.

In some embodiments, a financial adviser/planner may be able to use the classification to assist in providing useful financial advice and planning to the user. Additionally, the user may complete a prioritization of financial related concerns by using the systems and methods described in U.S. patent application Ser. No. 13/690,854 filed Nov. 30, 2012, entitled “SYSTEMS AND METHODS FOR OBTAINING PRIORITIZED USER INPUT,” the entire disclosure of which is hereby incorporated by reference, for all purposes, as if fully set forth herein. Priorities determined from such systems and methods may further aid the financial adviser/planner in providing useful financial advice and planning to the user.

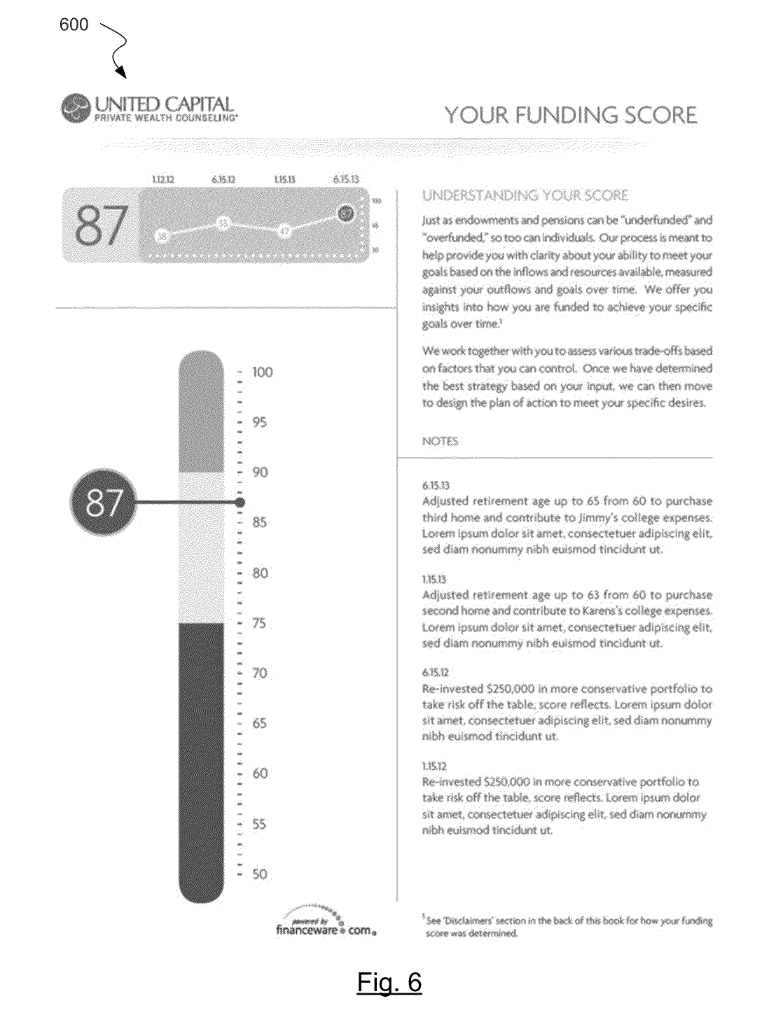

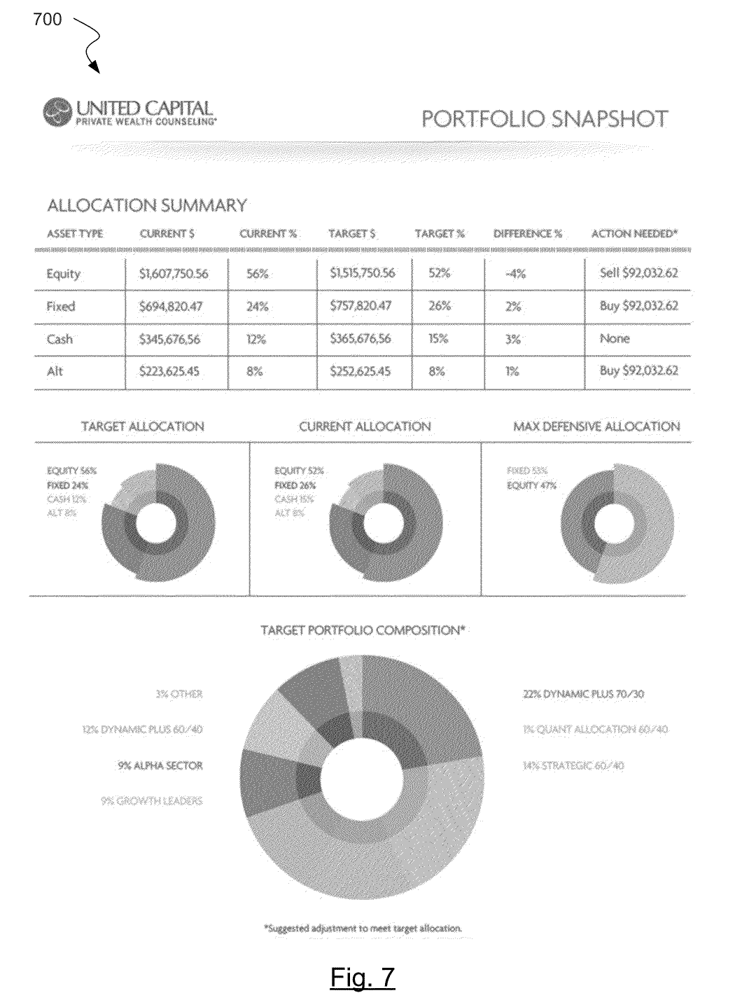

Additionally current financial information may also be received from the user to assist the financial adviser/planner. In some embodiments, a computer system may take into account the classification of the first user's attitude toward financial resources, the prioritization of the plurality of concerns from the first user, and/or the current financial information received from the first user, to determine an initial financial control score. The initial financial control score indicates a likelihood that a future financial goal will be achieved by the first user. An example of such a financial control score is shown in FIG. 6 via interface 600. Updated financial information may be provided by the user to update the financial control score. A client portal may also be provided as the user continues to manage their financial resources, and may include information such as that shown in FIG. 7 at interface 700. Additionally, any of the information discussed herein may be provided in a hardcopy, and either the hardcopy or digital version of such information may be referred to a “guidebook.”

In some embodiments, the method may further include receiving, by the computer system, from the first user, identification of at least one potential change to the current financial information. The computer system may then determine, based at least in part on the at least one potential change, a potential financial control score. In this manner, the computer system has determined what effect the potential change (e.g., increasing current spending, changing of long-term priorities, etc.) will have on long term financial health and/or goals.

If the computer system determines that the potential financial control score is less than a pre-established threshold, then at least one alternative potential change to the current financial information will be provided which will result in the financial control score returning to or exceeding the pre-established threshold. For example, if the first user wishes to make a certain expenditure now or in the future, the alternative change could be an extended retirement date, or increased savings, in order to maintain the financial control score above the pre-established threshold.

If the computer system determines that the potential financial control score is greater than a pre-established threshold, then at least one alternative potential change to the current financial information will be provided which will result in the financial control score remaining greater than the pre-established threshold or perhaps another lower pre-established threshold. For example, if the first user wishes decides to start saving more than previously planned, the alternative change could be an earlier retirement date, or increased recreational expenditures, since it is possible to do so and maintain the financial control score above the pre-established threshold.

Essentially then, embodiments of the invention provide systems and methods for advising users on current and future financial plans based on desired outcomes rather than on the user's tolerance for risk. Thus, once the systems and methods of the invention understand the likely outcome of the user's present financial course, alternatives can be provided which maximize any predicted future overages, and compensate for any predicted future shortfalls.

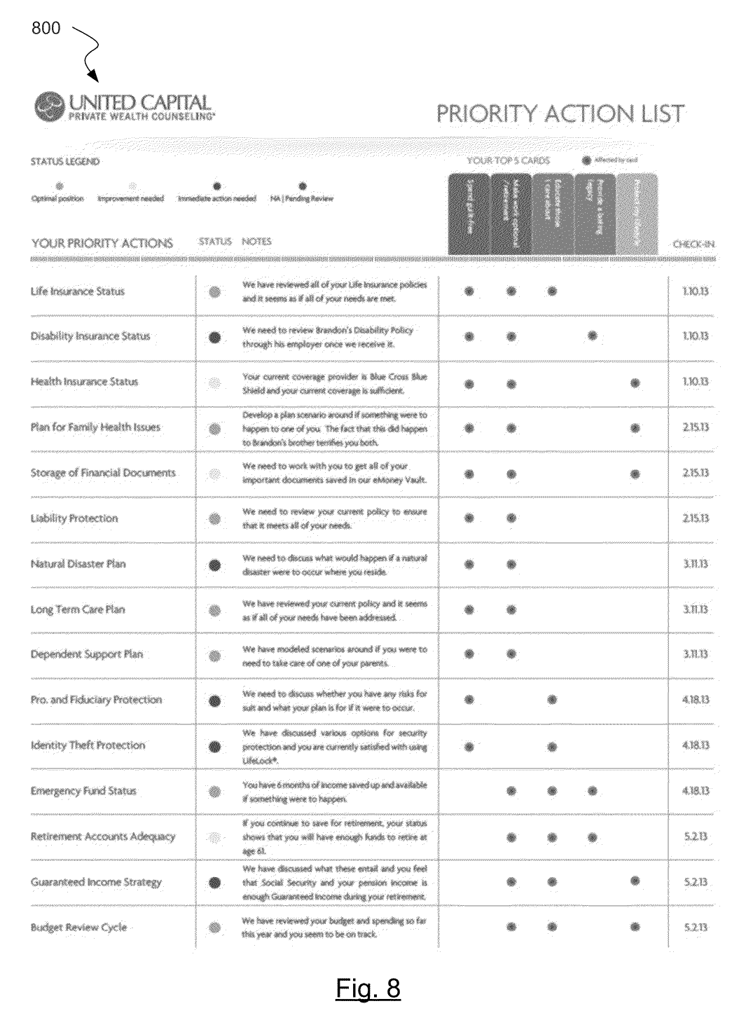

FIG. 8 is a priority action list 800 which may be created and stored by the computer system which indicates a plurality of action items and a current status of each action item. These action items may be determined based at least in part on the classification of the first user's attitude toward financial resources, the prioritization of the plurality of concerns from the first user, and/or the current or updated financial information received from the first user. A current status may also be associated with each action item in priority action list 800. Additionally, each action item in priority action list 800 may have a relationship with at least one of the plurality of concerns previously prioritized by the user, and such may be indicated in the priority action list. Priority action list 800 may be accessed in either a hardcopy or electronic form (e.g., user interface) of the “guidebook.”

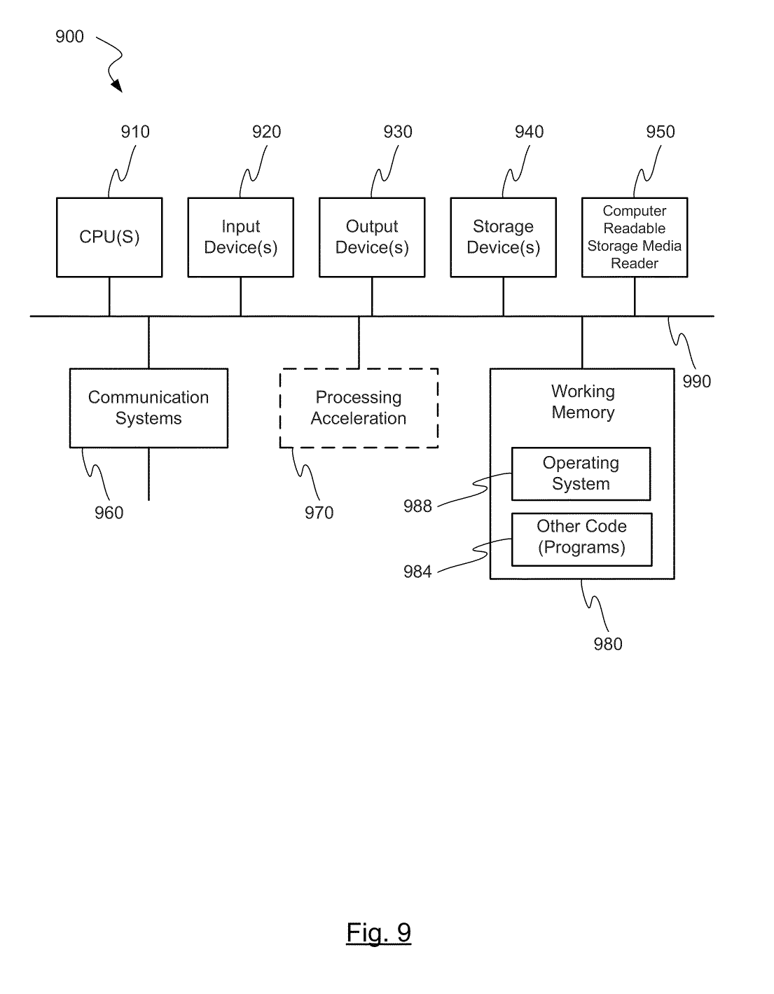

FIG. 9 is a block diagram illustrating an exemplary computer system 900 in which embodiments of the present invention may be implemented. This example illustrates a computer system 900 such as may be used, in whole, in part, or with various modifications, to implement the methods of the discussed above. For example, various functions may be controlled by the computer system 900, including, merely by way of example, displaying interfaces, determining results from queries, etc.

The computer system 900 is shown comprising hardware elements that may be electrically coupled via a bus 990. The hardware elements may include one or more central processing units 910, one or more input devices 920 (e.g., a mouse, a keyboard, etc.), and one or more output devices 930 (e.g., a display device, a printer, etc.). The computer system 900 may also include one or more storage device 940. By way of example, storage device(s) 940 may be disk drives, optical storage devices, solid-state storage device such as a random access memory (“RAM”) and/or a read-only memory (“ROM”), which can be programmable, flash-updateable and/or the like.

The computer system 900 may additionally include a computer-readable storage media reader 950, a communications system 960 (e.g., a modem, a network card (wireless or wired), an infra-red communication device, Bluetooth™ device, cellular communication device, etc.), and working memory 980, which may include RAM and ROM devices as described above. In some embodiments, the computer system 900 may also include a processing acceleration unit 970, which can include a digital signal processor, a special-purpose processor and/or the like.

The computer-readable storage media reader 950 can further be connected to a computer-readable storage medium, together (and, optionally, in combination with storage device(s) 940) comprehensively representing remote, local, fixed, and/or removable storage devices plus storage media for temporarily and/or more permanently containing computer-readable information. The communications system 960 may permit data to be exchanged with a network, system, computer and/or other component described above.

The computer system 900 may also comprise software elements, shown as being currently located within a working memory 980, including an operating system 984 and/or other code 988. It should be appreciated that alternate embodiments of a computer system 900 may have numerous variations from that described above. For example, customized hardware might also be used and/or particular elements might be implemented in hardware, software (including portable software, such as applets), or both. Furthermore, connection to other computing devices such as network input/output and data acquisition devices may also occur.

Software of computer system 900 may include code 988 for implementing any or all of the function of the various elements of the architecture as described herein. For example, software, stored on and/or executed by a computer system such as system 900, can provide the functions of various embodiments of the invention such as those discussed above. Methods implementable by software on some of these components have been discussed above in more detail.

The invention has now been described in detail for the purposes of clarity and understanding. However, it will be appreciated that certain changes and modifications may be practiced within the scope of the appended claims.

What is claimed is:

1. A method for receiving and analyzing inputs from at least one user to modify a financial plan of the at least one user with a computer system, wherein the method comprises:
receiving, at the computer system, biographical information from a first user;
displaying, by the computer system, a plurality of images to the first user, wherein each of the plurality of images is associated with a different query for the first user;
receiving, at the computer system, an instruction from the first user to randomly select a subset of the plurality of images;
selecting, randomly, by the computer system, a subset of the plurality of images for presentation to the first user;
displaying, by the computer system, to the first user the subset of the plurality of images in a different manner from a remainder of the plurality of images;
repeating, for each and every image of the subset of images:
receiving, at the computer system, from the first user a selection of one of the subset of the plurality of images;
displaying, by the computer system, to the first user a query associated with the selection; and
receiving, at the computer system, an answer from the first user to the query associated with the selection;
determining, by the computer system, from the answers for the queries associated with the images, a classification of the first user's attitude toward financial resources; and
storing, by the computer system, the classification in association with the first user's biographical information.

2. The method for receiving and analyzing inputs from at least one user to modify a financial plan of the at least one user with a computer system of claim 1, wherein the method further comprises:
receiving, at the computer system, a prioritization of a plurality of concerns from the first user; and
storing, by the computer system, the prioritization of the plurality of concerns in association with the first user's biographical information.

3. The method for receiving and analyzing inputs from at least one user to modify a financial plan of the at least one user with a computer system of claim 2, wherein the method further comprises:
receiving, at the computer system, current financial information from the first user; and
storing, by the computer system, the current financial information in association with the first user's biographical information.

4. The method for receiving and analyzing inputs from at least one user to modify a financial plan of the at least one user with a computer system of claim 3, wherein the method further comprises:
determining, by the computer system, based at least in part on the classification of the first user's attitude toward financial resources, the prioritization of the plurality of concerns from the first user, and/or the current financial information received from the first user, an initial financial control score, wherein the initial financial control score indicates a likelihood that a future financial goal will be achieved by the first user; and
storing, by the computer system, the initial financial control score.

5. The method for receiving and analyzing inputs from at least one user to modify a financial plan of the at least one user with a computer system of claim 4, wherein the method further comprises:
receiving, by the computer system, from the first user, identification of at least one potential change to the current financial information;
determining, by the computer system, based at least in part on the at least one potential change, a potential financial control score.

6. The method for receiving and analyzing inputs from at least one user to modify a financial plan of the at least one user with a computer system of claim 5, wherein the method further comprises:
determining, by the computer system, that the potential financial control score is less than a pre-established threshold;
providing, by the computer system, to the first user, at least one alternative potential change to the current financial information that will result in the financial control score returning to or exceeding the pre-established threshold.

7. The method for receiving and analyzing inputs from at least one user to modify a financial plan of the at least one user with a computer system of claim 5, wherein the method further comprises:
determining, by the computer system, that the potential financial control score is greater than a first pre-established threshold;
providing, by the computer system, to the first user, at least one alternative potential change to the current financial information that will result in the financial control score remaining greater than the a second pre-established threshold.

8. The method for receiving and analyzing inputs from at least one user to modify a financial plan of the at least one user with a computer system of claim 4, wherein the method further comprises:
receiving, at the computer system, updated financial information from the first user; and
storing, by the computer system, the updated financial information in associated with the first user's biographical information.

9. The method for receiving and analyzing inputs from at least one user to modify a financial plan of the at least one user with a computer system of claim 8, wherein the method further comprises:
determining, by the computer system, based at least in part on the classification of the first user's attitude toward financial resources, the prioritization of the plurality of concerns from the first user, and/or the updated financial information received from the first user, an updated financial control score, wherein the updated financial control score indicates a likelihood that the future financial goal will be achieved by the first user; and
storing, by the computer system, the updated financial control score.

10. The method for receiving and analyzing inputs from at least one user to modify a financial plan of the at least one user with a computer system of claim 8, wherein the updated financial information comprises:
information based at least in part on guidance provided by a financial adviser.

11. The method for receiving and analyzing inputs from at least one user to modify a financial plan of the at least one user with a computer system of claim 3, wherein the method further comprises:
displaying, by the computer system, a client portal to the first user, wherein the client portal displays the current financial information.

12. The method for receiving and analyzing inputs from at least one user to modify a financial plan of the at least one user with a computer system of claim 8, wherein the method further comprises:
displaying, by the computer system, a client portal to the first user, wherein the client portal displays the updated financial information.

13. The method for receiving and analyzing inputs from at least one user to modify a financial plan of the at least one user with a computer system of claim 1, wherein the classification of the first user's attitude toward financial resources is selected from a group consisting of:
a fear focus, wherein the fear focus user has a primary goal to seek security and/or safety;
a happiness focus, wherein the happiness focus user has a primary goal to seek satisfaction; and
a commitment focus, wherein the commitment focus user has a primary goal to take care of others.

14. The method for receiving and analyzing inputs from at least one user to modify a financial plan of the at least one user with a computer system of claim 3, wherein the method further comprise:
determining, by the computer system, based at least in part on the classification of the first user's attitude toward financial resources, the prioritization of the plurality of concerns from the first user, and/or the current financial information received from the first user, a priority action list, wherein the priority action list indicates a plurality of action items and a current status of each action item; and
storing, by the computer system, the priority action list.

15. The method for receiving and analyzing inputs from at least one user to modify a financial plan of the at least one user with a computer system of claim 14, wherein the priority action list further:
indicates a relationship between at least one of the actions items and at least one of the plurality of concerns of the user.

16. A system for receiving and analyzing inputs from at least one user to modify a financial plan of the at least one user, wherein the system comprises:
a computer system for:
receiving biographical information from a first user;
displaying a plurality of images to the first user, wherein each of the plurality of images is associated with a different query for the first user;
receiving an instruction from the first user to randomly select a subset of the plurality of images;
selecting, randomly, a subset of the plurality of images for presentation to the first user;
displaying to the first user the subset of the plurality of images in a different manner from a remainder of the plurality of images;
repeating, for each and every image of the subset of images:
receiving from the first user a selection of one of the subset of the plurality of images;
displaying to the first user a query associated with the selection; and
receiving an answer from the first user to the query associated with the selection;
determining from the answers for the queries associated with the images, a classification of the first user's attitude toward financial resources; and
storing the classification in association with the first user's biographical information.

17. The system for receiving and analyzing inputs from at least one user to modify a financial plan of the at least one user of claim 16, wherein the system further comprises:
receiving a prioritization of a plurality of concerns from the first user; and
storing the prioritization of the plurality of concerns in association with the first user's biographical information.

18. The system for receiving and analyzing inputs from at least one user to modify a financial plan of the at least one user of claim 17, wherein the system further comprises:
receiving current financial information from the first user; and
storing the current financial information in association with the first user's biographical information.

19. The system for receiving and analyzing inputs from at least one user to modify a financial plan of the at least one user of claim 18, wherein the system further comprises:
determining based at least in part on the classification of the first user's attitude toward financial resources, the prioritization of the plurality of concerns from the first user, and/or the current financial information received from the first user, an initial financial control score, wherein the initial financial control score indicates a likelihood that a future financial goal will be achieved by the first user; and
storing the initial financial control score.

20. The system for receiving and analyzing inputs from at least one user to modify a financial plan of the at least one user of claim 19, wherein the system further comprises:
receiving updated financial information from the first user; and
storing the updated financial information in associated with the first user's biographical information.

21. A non-transitory machine readable medium having instructions thereon, the instructions executable by a processor for receiving and analyzing inputs from at least one user to modify a financial plan of the at least one user, wherein the instructions are executable for at least:
receiving biographical information from a first user;
displaying a plurality of images to the first user, wherein each of the plurality of images is associated with a different query for the first user;
receiving an instruction from the first user to randomly select a subset of the plurality of images;
selecting, randomly, a subset of the plurality of images for presentation to the first user;
displaying to the first user the subset of the plurality of images in a different manner from a remainder of the plurality of images;
repeating, for each and every image of the subset of images:
receiving from the first user a selection of one of the subset of the plurality of images;
displaying to the first user a query associated with the selection; and
receiving an answer from the first user to the query associated with the selection;
determining from the answers for the queries associated with the images, a classification of the first user's attitude toward financial resources; and
storing the classification in association with the first user's biographical information.

22. The non-transitory machine readable medium having instructions thereon, the instructions executable by a processor for receiving and analyzing inputs from at least one user to modify a financial plan of the at least one user of claim 21, wherein the instructions are further executable for at least:
receiving a prioritization of a plurality of concerns from the first user; and
storing the prioritization of the plurality of concerns in association with the first user's biographical information.

23. The non-transitory machine readable medium having instructions thereon, the instructions executable by a processor for receiving and analyzing inputs from at least one user to modify a financial plan of the at least one user of claim 22, wherein the instructions are further executable for at least:
receiving current financial information from the first user; and
storing the current financial information in association with the first user's biographical information.

24. The non-transitory machine readable medium having instructions thereon, the instructions executable by a processor for receiving and analyzing inputs from at least one user to modify a financial plan of the at least one user of claim 23, wherein the instructions are further executable for at least:
determining based at least in part on the classification of the first user's attitude toward financial resources, the prioritization of the plurality of concerns from the first user, and/or the current financial information received from the first user, an initial financial control score, wherein the initial financial control score indicates a likelihood that a future financial goal will be achieved by the first user; and
storing the initial financial control score.

25. The non-transitory machine readable medium having instructions thereon, the instructions executable by a processor for receiving and analyzing inputs from at least one user to modify a financial plan of the at least one user of claim 24, wherein the instructions are further executable for at least:
receiving updated financial information from the first user; and
storing the updated financial information in associated with the first user's biographical information.
